(19) United States
(12) Patent Application Publication
(10) Pub. No.: US 2018/0238749 A1
(43) Pub. Date: Aug. 23, 2018

(54) FORCE SENSOR UNIT

(71) Applicant: Hokuriku Electric Industry Co., Ltd., Toyama-shi, Toyama (JP)

(72) Inventors: Masashi Doko, Toyama-shi, Toyama (JP); Tsutomu Sawai, Toyama-shi, Toyama (JP); Hiroki Hayashi, Toyama-shi, Toyama (JP)

(21) Appl. No.: 15/542,473

(22) PCT Filed: Jan. 12, 2016
(86) PCT No.: PCT/JP2016/050638

§ 371 Date: Jul. 10, 2017

(30) Foreign Application Priority Data
Jan. 13, 2015 (JP) 2015-004349

(51) Int. Cl. G01L 1/04; G01L 1/14; G01L 1/26

(52) U.S. Cl. CPC G01L 1/042; G01L 1/26; G01L 1/142

(57) ABSTRACT

A force sensor unit having a simple structure to allow ready assembling and easy downsizing of the force sensor unit. The force sensor unit includes a cylindrical body, a substrate that blocks one end of the cylindrical body, a force sensor that is supported on the substrate, and a force transmission mechanism that is disposed in an internal space of the cylindrical body to transmit a force to the force sensor. The force transmission mechanism includes a contact member, a coil spring, and an operated member. These members are arranged in order in the internal space of the cylindrical body, and are not adhered to nor engaged with each other. The members except the substrate are simply fitted loosely in the internal space of the cylindrical body, thereby facilitating assembling of the force sensor unit and enabling downsizing of the force sensor unit.

### TECHNICAL FIELD

The present invention relates to a force sensor unit that detects a force externally applied and outputs an electrical signal according to the magnitude of the force with high accuracy, and more specifically to a force sensor unit that has a simple structure to be readily assembled and that allows downsizing.

### BACKGROUND ART

JP05-92656U1 (Publication of Japanese Utility Model Application) discloses a load cell in FIG. 1. In this load cell, a metallic cylindrical diaphragm 6, of which one end is blocked with a thin portion 7, is disposed inside a case 2 having a through hole 5 formed therein such that the diaphragm 6 blocks an opening portion 5a located at one end of the through hole 5; a load receiving portion 9 is disposed on a side of an opening portion 5b located at the other end of the through hole 5 so as to be movable within a predetermined range; and a spring 11 is disposed between a rigid ball 12 and the load receiving portion 9. This load cell detects a load acting on the receiving portion 9 with a strain gauge 8 provided at the thin portion 7 of the metallic diaphragm 6 when a load, which has acted on the load receiving portion 9, acts on the metallic diaphragm 6 via the spring 11 and the rigid ball 12.

### BACKGROUND ART DOCUMENT

### Patent Document

Patent Document 1: JP05-92656U1, FIG. 1

### SUMMARY OF INVENTION

### Technical Problems

In many cases, a force sensor includes a pressure receiving portion having a function of restricting the width of mechanical displacement of a force sensor element for the purpose of preventing the force sensor from being damaged when an impact or an excessive force is applied to the force sensor. The pressure receiving portion shown in JP05-92656U1 is the rigid ball 12 of which the surface contacts a diaphragm. In the configuration shown in JP05-92656U1, the spring 11 that contacts the rigid ball 12 is disposed on an opposite side to a portion of the rigid ball 12 that contacts the diaphragm 6. The spring 11 works to increase a stroke of the load receiving portion 9. As with conventional force sensors, however, if the rigid ball 12 is in direct contact with the spring, the attitude of the spring changes when the spring is stretched, thereby displacing the contact position between the ball and the spring. As a result, the direction of a force applied to the ball via the spring slightly changes, thereby causing variations in output from the force sensor. Further, downsizing is very difficult for the configuration shown in JP05-92656U1.

An object of the present invention is to provide a force sensor unit that has a simple structure to be readily assembled and allows easy downsizing.

Another object of the present invention is to provide a force sensor unit in which a contact member contacting a pressure receiving portion of the force sensor is prevented from being rotated, but can smoothly be caused to slide.

A further object of the present invention is to provide a force sensor unit that allows for easy fabrication of multiple substrates each having a force sensor unit mounted on one surface thereof, thereby facilitating manufacturing of the substrates.

A yet another object of the present invention is to provide a force sensor unit in which variations in operating characteristics can be suppressed especially when the force sensor unit is downsized.

A still another object of the present invention is to provide a force sensor unit in which the stroke of an operated member can be maximized and a force likely to damage the force sensor can be prevented from being applied to a pressure receiving portion of the force sensor.

Another object of the present invention is to provide a force sensor unit that allows for easy mounting of a blocking member that blocks one end of a cylindrical body of the force sensor unit.

A further object of the present invention is to provide a force sensor unit in which claw portions constituting a mounting structure of the blocking member do not hinder implementation of the force sensor unit.

### Solution to Problems

The present invention is directed to a force sensor unit including a cylindrical body, a blocking member that blocks one end of the cylindrical body, a force sensor supported on the blocking member, and a force transmission mechanism disposed inside an internal space of the cylindrical body to transmit a force to the force sensor. The force sensor unit of the present invention is provided with a stopper at the other end of the cylindrical body. The stopper includes an opening portion that communicates with the internal space of the cylindrical body and extends radially inward. The force transmission mechanism includes a contact member that contacts a force receiving portion of the force sensor, an operated member including an operated portion exposed from the opening portion of the cylindrical body and an engaged portion to be engaged with the stopper, and an elastic member disposed between the contact member and the operated member. The contact member and the operated member each include a slide portion that faces an inner wall surface surrounding the internal space of the cylindrical body. The respective slide portions of the contact member and the operated member are capable of sliding inside the internal space and are shaped to allow them to slide along a centerline of the cylindrical body.

In the force sensor unit of the present invention, the force sensor supported on the blocking member that blocks one end of the cylindrical body, the contact member, the elastic member, and the operated member are arranged in order in the internal space of the cylindrical body. At the time of assembling the force sensor unit, these members are inserted in order into the cylindrical body from an opening at one end of the cylindrical body. First, the operated member is inserted such that the operated portion of the operated member is engaged with the stopper provided at the other end of the cylindrical body, that the operated portion is exposed from the opening portion located at the other end of the cylindrical body, and that the slide portion of the operated member is situated to face an inner wall surface of the cylindrical body. Next, the elastic member is inserted and then the contact member is inserted such that the slide portion of the contact member is situated to face the inner wall surface of the cylindrical body. Finally, one end of the cylindrical body is blocked by the blocking member such that the force sensor is situated in the internal space of the cylindrical body. When assembling of the members is completed, the members arranged in order are not adhered to each other nor are engaged with each other. The members except the blocking member are simply situated in the internal space.

In the force sensor unit thus assembled, when a force is externally applied to the operated portion of the operated member, the operated member is caused to slide along the centerline of the cylindrical body inside the internal space toward the force sensor from an initial position where the engaged portion of the operated member is engaged with the stopper. Then, the operated member compresses the elastic member, and the elastic member, in turn, pushes the contact member to cause the contact member to slide along the centerline of the cylindrical body toward the force sensor inside the internal space of the cylindrical body. Thus, the applied force is transmitted to the pressure receiving portion of the force sensor. Due to the buffer function of the elastic member, the sliding width of the contact member is shorter than that of the operated member. The pressure receiving portion in contact with the contact member is pushed by the contact member and is moved, thereby causing the force sensor element to be mechanically displaced. As a result, an electrical signal is output according to the magnitude of the force applied to the operated portion of the operated member. Once the force applied to the operated portion disappears, the force sensor element is returned from the mechanical displacement to push the pressure receiving portion. Then, the pressure receiving portion is moved to cause the contact member in contact with the pressure receiving portion to slide away from the force sensor. Following that, the elastic member is stretched to cause the operated member to slide away from the force sensor. Then, the engaged portion is engaged with the stopper to stop. Thus, the operated member is returned to its initial position.

According to the present invention, the force sensor unit can be assembled through a simple process as follows: each member is inserted in order into the cylindrical body from an opening at one end of the cylindrical body and finally an opening located at the other end of the cylindrical body is blocked by the blocking member. The force transmission mechanism is constituted from the operated member, the elastic member, and the contact member. By interposing the elastic member having the buffer function between the operated member and the contact member, the stroke of the sliding operated member can be increased.

According to the present invention, the above-mentioned configuration enables downsizing of the force sensor unit. Further, since the contact member is disposed between the pressure receiving portion of the force sensor and the elastic member, the contact position between the pressure receiving portion and the contact member substantially does not change in the process of deformation of the elastic member. Consequently, variations in force detecting accuracy can be suppressed.

In the force sensor unit of the present invention, it is preferred that a cross section of the internal space of the cylindrical body has a polygonal outline shape and that the slide portion of the contact member is shaped to prevent the contact member from being rotated around the centerline of the cylindrical body by contacting the inner wall surface of the cylindrical body. With such configuration of the force sensor unit, output variations in the force sensor due to the rotation of the contact member can be suppressed by preventing the contact member in contact with the pressure receiving portion from being rotated. Further, when the pressure receiving member is formed a sphere, the life of the force sensor can be extended by preventing the pressure receiving portion from being rotated. Especially when the force sensor unit is small-sized, the inner wall surface of the cylindrical body and the slide portion of the contact member that have a polygonal outline or are shaped in a polygonal cylinder (column) can be manufactured with higher accuracy than those shaped in round cylinder (column). Therefore, the contact member can smoothly slide inside the cylindrical body, thereby preventing twisting and twirling of the contact member.

Further, it is preferred that a cross section of an outer peripheral surface of the cylindrical body has a polygonal outline shape; that the blocking member includes a substrate having a front surface positioned on a side of the internal space of the cylindrical body, on which the force sensor is mounted, and a back surface having a plurality of electrodes provided thereon and exposed externally from the cylindrical body; and that an outline shape of the substrate is the same as or similar to the outline shape of the cross section of the outer peripheral surface of the cylindrical body. Such configuration of the force sensor unit allows easy fabrication of multiple substrates each having a force sensor unit mounted on one surface thereof, thereby facilitating manufacturing of the substrates. This contributes to price reduction of the force sensor units.

In the force sensor unit of the present invention, the elastic member is preferably formed of a coil spring.

In this configuration, variations in operating characteristics can be suppressed even when the force sensor unit is downsized.

In the force sensor unit of the present invention, it is preferred that the elastic member has an elastic constant that is defined to maximize a stroke of the operated member when a maximum allowable measurement force (a maximum allowable force to be measured) is applied to the force sensor. With this arrangement, the stroke of the operated member can be maximized and a force likely to damage the force sensor can be prevented from being applied to the pressure receiving portion.

Further, in the force sensor unit of the present invention, it is preferred that the blocking member includes a substrate having a front surface positioned on a side of the internal space of the cylindrical body, on which the force sensor is mounted, and a back surface having a plurality of electrodes provided thereon and exposed externally from the cylindrical body; and that the cylindrical body is metallic and includes two or more claw portions that are provided at one end of the cylindrical body and are bent in the radially inward direction to contact the back surface of the substrate. In this configuration, the blocking member that blocks one end of the cylindrical body can easily be mounted by bending the claw portions of the cylindrical body radially inward.

In the force sensor unit of the present invention, it is preferred that an abutted portion is provided on the front surface of the substrate to abut onto an end face of the one end of the cylindrical body; and that a plurality of recesses are formed in the back surface of the substrate to be engaged with the claw portions. In this configuration, the claw portions constituting the mounting structure of the blocking member do not hinder implementation of the force sensor unit since the claw portions are fitted in the recesses formed in the back surface of the substrate. The size of the force sensor unit as measured in the centerline direction can be reduced.

### BRIEF DESCRIPTION OF DRAWINGS

FIG. 1 is a perspective view illustrating an embodiment of a force sensor unit according to the present invention. In the figure, the cylindrical body is partially cut off.

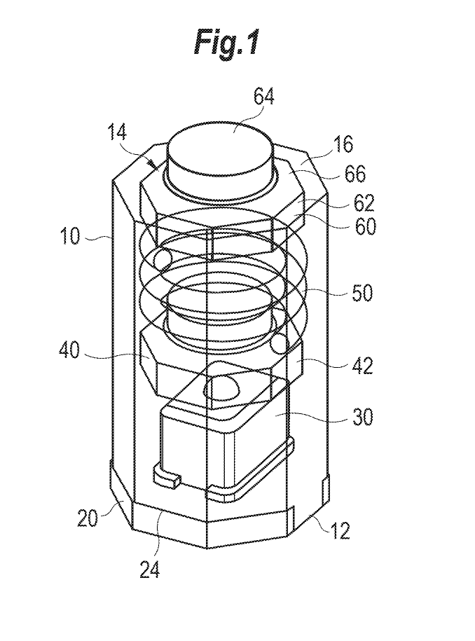

FIGS. 2A and 2B are each a longitudinally cross sectional view of the embodiment of FIG. 1. FIG. 2A illustrates that the operated portion is situated in its initial position. FIG. 2B illustrates that the operated portion is pushed to its ultimate position.

FIG. 3 is a bottom plan view of the embodiment of FIG. 1.

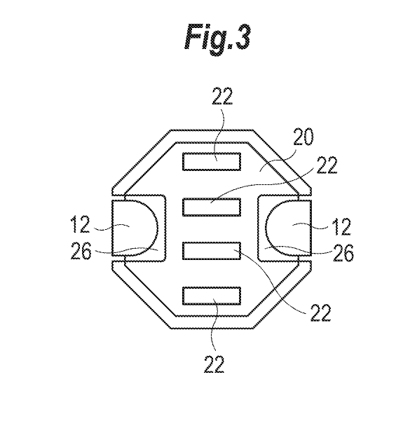

FIG. 4 illustrates the force sensor unit of the embodiment of FIG. 1 in a disassembled state.

### DESCRIPTION OF EMBODIMENT

Now, an embodiment of the present invention will be described below in detail with reference to the accompanying drawings. As illustrated in the figures, a force sensor unit of the present invention comprises a cylindrical body 10, a substrate 20 that blocks one end of the cylindrical body 10, a force sensor 30 supported on the substrate 20, and a force transmission mechanism disposed in an internal space of the cylindrical body 10 and operable to transmit a force to the force sensor 30. The transmission mechanism includes a contact member 40, a coil spring 50, and an operated member 60. The force sensor unit of the present embodiment is small-sized, having a total length of about 7 mm and a maximum outer diameter of about 4 mm. The force sensor 30 is cubic in shape with each side being about 2 mm. The maximum allowable width of mechanical displacement of a force sensor element is about 0.1 μm or less.

The cylindrical body 10 is shaped in octagonal cylinder (column). Therefore, a cross section of the internal space of the cylindrical body 10 has an octagonal outline shape and a cross section of an outer peripheral surface of the cylindrical body 10 also has an octagonal shape. The cylindrical body 10 is metallic and is provided with two claw portions 12, 12 at one end thereof . The claw portions 12,12 are bent radially inward to contact a back surface of the substrate 20. At the other end of the cylindrical body 10, a circular opening portion 14 communicating with the internal space is provided in the vicinity of the center of the other end, and a ring-shaped stopper 16 extending radially inward of the cylindrical body 10 is provided in the vicinity of a periphery of the other end.

The substrate 20 has a front surface positioned on a side of the internal space of the cylindrical body, on which the force sensor 30 is mounted, and a back surface having four electrodes 22 provided thereon and exposed externally from the cylindrical body 10. The outline shape of the substrate 20 is octagonal, the same as the outline shape of the cross section of the outer peripheral surface of the cylindrical body 10. The octagonal outline shape of the substrate 20 makes it easy to fabricate multiple substrates 20, thereby facilitating manufacturing of the substrates 20. As a result, the price of the force sensor unit can be reduced. An abutted portion 24 is provided on the front surface of the substrate 20 to abut onto an end face of the one end of the cylindrical body 10. Two recesses 26, 26 are formed in the back surface of the substrate 20. The recesses 26, 26 are shaped complementarily with the two claw portions 12, 12 of the cylindrical body 10. The two claw portions 12, 12 are bent to be engaged in the recesses 26, 26.

The force sensor 30 is supported on the substrate 20. The force sensor 30 includes a pressure receiving portion 32, a case 34, and a force sensor element 36. The pressure receiving portion 32 is a sphere and is exposed from the top surface of the case 34. The case 34 is configured to restrict the movement of the pressure receiving portion 32. The force sensor element 36 is in contact with the pressure receiving portion 32 and is configured to be mechanically displaced when a force is applied from the pressure receiving portion 32. The mechanical displacement of the force sensor element 36 is converted into an electrical signal. The electrical signal is then output from electrodes 22 of the substrate 20.

The contact member 40 is in contact with the pressure receiving portion 32 of the force sensor 30 to transmit a force to the pressure receiving portion 32. The cross section of the contact member 40 is octagonal in shape as is substantially the same as that of the inner wall surface of the cylindrical body 10. The contact member 40 includes a slide portion 42 of which one end contacts the pressure receiving portion 32 of the force sensor 30 and a coil spring support portion 44 shaped in round column and projecting from the vicinity of the center of the other end of the slide portion 42. The side surface of the slide portion faces the inner wall surface of the cylindrical body 10 and is shaped to allow the slide portion 42 to slide along the center axis of the internal space of the cylindrical body 10.

The contact member 40 is prevented from being rotated by making the cross section of the contact member 40 and that of the inner wall surface of the cylindrical body 10 in an octagonal shape. Thus, it is possible to suppress variations in output from the force sensor 30 due to the rotation of the contact ember 40. In addition, the life of the force sensor 30 can be extended by preventing the pressure receiving portion 32 formed of a sphere from being rotated. Further, especially when the force sensor unit is small-sized, it is easier to manufacture the inner wall surface of the cylindrical body 10 and the slide portion that are shaped in an octagonal cylinder (column) including flat surfaces with high accuracy than in a round cylinder (column) of which the entire surface is curved. Thus, the contact member 40 can smoothly slide inside the cylindrical body 10, thereby preventing twisting and twirling of the contact member 40 from being caused.

The coil spring 50 is a compression spring and is disposed between the contact member 40 and the operated member 60 to work as a cushion, thereby suppressing variations in operating characteristics. Since the inside diameter of the coil spring 50 is substantially the same as that of the outside diameter of the coil spring support portion 44 of the contact member 40, the coil spring 50 is supported by the coil spring support portion 44 which has got into the coil spring 50. An elastic constant of the coil spring 50 is defined to maximize a stroke of the operated member 60 when a maximum allowable measurement force is applied to the force sensor 30.

The operated member 60 includes a slide portion 62, a round columnar operated portion 64, and an engaged portion 66. The cross section of the slide portion 62 is octagonal in shape as is substantially the same as the cross section of the inner wall surface of the cylindrical body 10 such that one end of the operated portion 60 is in contact with the coil spring 50 to slide along the centerline of the cylindrical body 10. The operated portion 64 projects from the vicinity of the center of the other end of the slide portion 62 and a leading portion of the operated portion 64 is exposed from an opening portion 14 of the cylindrical body 10 when the force sensor unit is assembled. The engaged portion 66 is formed of an end face of the other end of a portion of the slide portion 62 except a portion from which the operated portion 64 projects, and abuts against an inner surface of the stopper 16 of the cylindrical body 10 to be engaged with the stopper.

In the present embodiment, the contact member 40 and the operated member 60 are formed in substantially the same shape. In other embodiments, the shapes of the contact member and the operated member may be different.

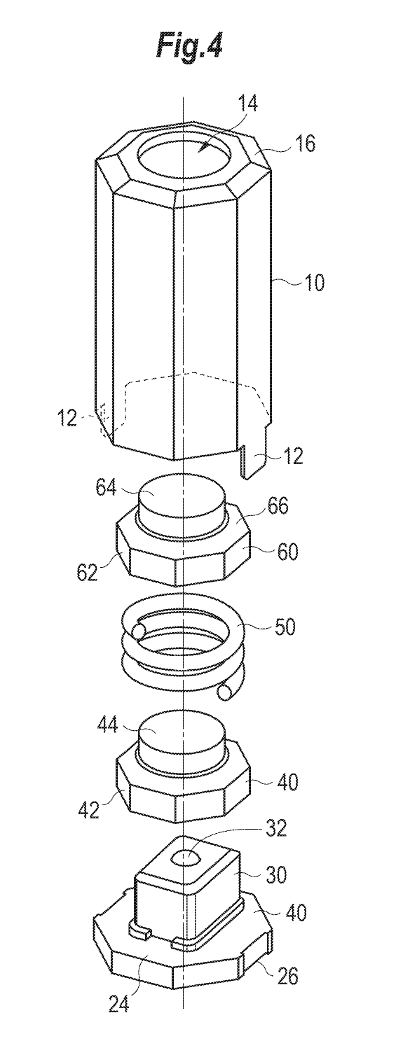

Next, referring to FIG. 4, the assembling process of the force sensor unit of the present embodiment will be described below. When assembling the force sensor unit of the present embodiment, each member is inserted in order from an opening at one end of the cylindrical body 10. First, the operated member 60 is inserted such that the engaged portion 66 abuts on the stopper 16 of the cylindrical body 10 located at the other end to be engaged with the stopper 16; that a leading portion of the operated portion 64 is exposed from the opening portion 14 of the cylindrical body 10 located at the other end; and that the slide portion 62 of the operated member 60 faces the inner wall surface of the cylindrical body 10. Next, the coil spring 50 is inserted. Then, the contact member 40 is inserted such that the coil spring support portion 44 faces the coil spring 50; and that the slide portion 42 of the contact member 40 faces the inner wall surface of the cylindrical body 10. Finally, an opening at the one end of the cylindrical body 10 is blocked by the substrate 20 in such a manner that the force sensor 30 is disposed in the internal space of the cylindrical body 10. The abutted portion 24 of the substrate 20 abuts on an end face of the one end of the cylindrical body 10. At this moment, angle adjustment is performed such that an angle between two claw portions 12, 12 projecting from one end of the cylindrical body 10 with respect to the centerline should be consistent with an angle between two recesses 26, 26 of the substrate 20. The claw portions 12, 12 are radially bent by 90 degrees to respectively fit in the two recesses 26, 26. Thus, the opening at the one end of the cylindrical body 10 is blocked. The fitting of the claw portions 12, 12 and the recesses 26, 26 does not hinder implementation of the force sensor unit and can minimize the size of the force sensor unit as measured along the centerline.

The members arranged in order inside the internal space of the cylindrical body 10 are not adhered to nor engaged with each other. The members except the substrate 20 are simply fitted loosely in the internal space of the cylindrical body 10, thereby facilitating assembling of the force sensor unit.

In the present embodiment, the force sensor unit can readily be assembled through such a simple process that the members are inserted in order into the internal space of the cylindrical body 10 and finally one end of the cylindrical body 10 is blocked by the substrate 20.

The assembled force sensor unit according to the present embodiment is received in a stylus pen. The electrodes 22 located at one end are connected with electric wires (not illustrated) for external output. The operated portion 64 of the operated member 60 located at the other end is in contact with an end face of one end of an operating member 70. The other end of the operating member 70 is a leading point of the stylus pen (alternatively, the other end of the operating member 70 is connected to a leading point of the stylus pen). A force generated by an operator of the stylus pen when pressing the stylus pen onto a panel is transmitted to the force sensor unit. The operating member 70 is capable of sliding along the centerline of the force sensor unit so as to approach or get away from the force sensor. Specifically, the operating member 70 is inserted into a hollow pen holder in which the force sensor unit is fixedly situated.

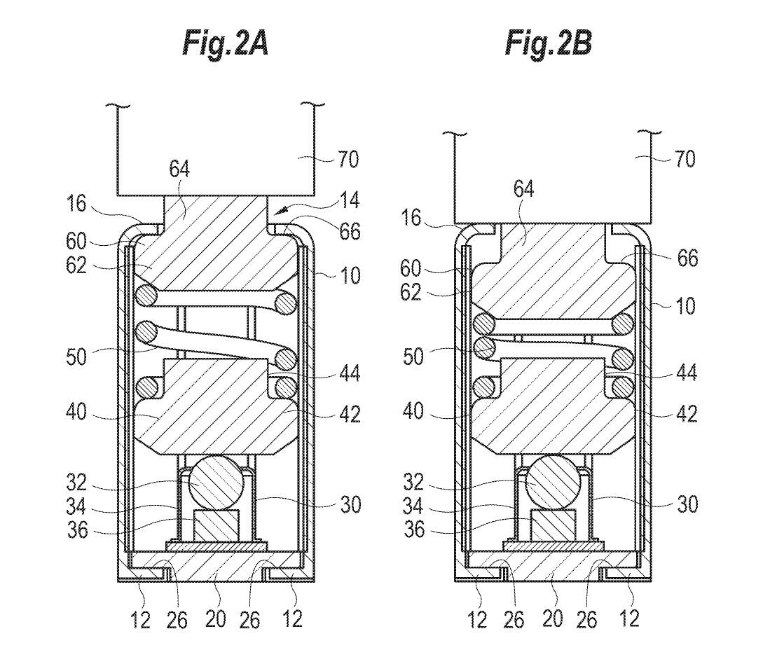

Next, referring to FIGS. 2A and 2B, the actions of the force sensor unit of the present embodiment will be described below. FIG. 2A illustrates that the operated member 60 is situated in its initial position with no force being applied to the force sensor unit. Namely, a leading part of the operated portion 64 of the operated member 60 is exposed from an opening portion 14 of the cylindrical body 10 and the engaged portion 66 is engaged with the stopper 16 of the cylindrical body 10.

FIG. 2B illustrates that the maximum allowable measurement force is being applied to the force sensor unit as an operator strongly presses the leading point of a stylus pen onto a touch panel. At this moment, the operated member 60 is pushed by the operating member 70 to slide from the initial position to the ultimate position toward the force sensor 30 along the centerline of the cylindrical body 10 inside the internal space of the cylindrical body 10.

The operated portion 60 compresses the coil spring 50, which in turn pushes the contact member 40. The contact member 40 slides toward the force sensor 30 along the centerline of the internal space of the cylindrical body 10. The force is thus transmitted to the pressure receiving portion 32 of the force sensor 30.

Due to the buffer function of the coil spring 50, however, the width over which the contact member 40 slides is significantly shorter than the width over which the operated member 60 slides. The pressure receiving portion 32 contacting the contact member 40 is pushed by the contact member 40 to move, which causes mechanical displacement of the force sensor element 36. As a result, an electrical signal is output from the electrodes 22 according to the magnitude of the force applied to the operated portion 64 of the operated member 60.

In the above-mentioned state, the length and the elastic constant of the coil spring 50 have been adjusted such that the magnitude of the force by which the coil spring 50 presses the contact member 40 is substantially equal to the maximum allowable measurement force. Namely, the operated member 60 is capable of sliding within a stroke from the initial position illustrated in FIG. 2A to the position illustrated in FIG. 2B where the maximum allowable measurement force is applied. The stroke is designed so as to allow the force sensor 30 to produce a stable output with safety within the stroke.

Once the leading point of the stylus pen leaves the touch panel and the force applied to the operated portion 64 of the operated member 60 disappears, the force sensor element 36 is returned from the mechanical displacement, and the pressure receiving portion 32 is pushed by the force sensor element 36 to move. Then, the contact member 40 contacting the pressure receiving portion 36 slides away from the force sensor 30 and the coil spring 50 is stretched. The operated member 60 slides away from the force sensor 30 and the engaged portion 66 is engaged with the stopper 16 to return to its initial position illustrated in FIG. 2A.

In the force sensor unit of the present invention, the force transmission mechanism is constituted from the operated member 60, the coil spring 50 as the elastic member, and the contact member 40. The stroke within which the operated member 60 slides can be increased by interposing the coil spring 50 having a buffer function between the operated member 60 and the contact member 40.

High accuracy is required for the stability in output from the force sensor 30 and the safety to avoid an excessive force to be applied to the force sensor 30. As can be known from the foregoing, the required high accuracy is focused only on the coil spring 50. Especially for the small-sized force sensors, the range within which the mechanical displacement of the force sensor element 36 is caused stably and without damage risk is very narrow. The width over which the mechanical displacement of the force sensor element 36 is caused is limited by disposing the coil spring 50 in the middle to convert a large stroke externally applied into a narrow width. For this reason, the length and the elastic constant of the coil spring 50 is adjusted as accurately as possible.

In addition to the foregoing, as illustrated in FIG. 2B, an end face of one end of the operating member 70 abuts on an outer surface of the stopper 16 to stop there. This prevents the force sensor 30 from being damaged in case, for example, an accident such that a stylus pen falls down occurs to apply a strong impact to the force sensor 30 from the operating member 70.

### INDUSTRIAL APPLICABILITY

According to the present invention, a force sensor unit has a simple structure to allow ready assembling and easy downsizing of the force sensor unit.

### DESCRIPTION OF REFERENCE NUMERALS

10 cylindrical body
12 claw portion
14 opening portion
16 stopper
20 substrate
22 electrode
24 abutted portion
26 recess
30 force sensor
32 pressure receiving portion
34 case
36 force sensor element
40 contact member
42 slide portion
44 coil spring support portion
50 coil spring
60 operated member
62 slide portion
64 operated portion
66 engaged portion
70 operating member

1. A force sensor unit comprising:
a cylindrical body;
a blocking member that blocks one end of the cylindrical body;
a force sensor supported on the blocking member; and
a force transmission mechanism disposed in an internal space of the cylindrical body and operable to transmit a force to the force sensor, wherein:
the cylindrical body is provided with a stopper at the other end of the cylindrical body, the stopper having an opening portion to communicate with the internal space of the cylindrical body and extending in a radially inward direction of the cylindrical body;
the force transmission mechanism includes:
a contact member that contacts a force receiving portion of the force sensor;
an operated member including an operated portion exposed from the opening portion of the cylindrical body and an engaged portion to be engaged with the stopper; and
an elastic member disposed between the contact member and the operated member;
the contact member and the operated member each include a slide portion facing an inner wall surface of the cylindrical body, which surrounds the internal space of the cylindrical body, and capable of sliding in the internal space and shaped to allow the respective slide portions of the contact member and the operated member to slide along a centerline of the cylindrical body;
a cross section of the internal space of the cylindrical body has a polygonal outline shape;
the slide portion of the contact member is shaped to prevent the contact member from being rotated around the centerline of the cylindrical body by contacting the inner wall surface of the cylindrical body;
the blocking member includes a substrate having a front surface positioned on a side of the internal space of the cylindrical body, on which the force sensor is mounted, and a back surface having a plurality of electrodes provided thereon and exposed externally from the cylindrical body; and
an outline shape of the substrate is the same as or similar to the outline shape of the cross section of the outer peripheral surface of the cylindrical body.

2. A force sensor unit comprising:
a cylindrical body;
a blocking member that blocks one end of the cylindrical body;
a force sensor supported on the blocking member; and
a force transmission mechanism disposed in an internal space of the cylindrical body and operable to transmit a force to the force sensor, wherein:
the cylindrical body is provided with a stopper at the other end of the cylindrical body, the stopper having an opening portion to communicate with the internal space of the cylindrical body and extending in a radially inward direction of the cylindrical body;
the force transmission mechanism includes:
a contact member that contacts a force receiving portion of the force sensor;
an operated member including an operated portion exposed from the opening portion of the cylindrical body and an engaged portion to be engaged with the stopper; and
an elastic member disposed between the contact member and the operated member; and
the contact member and the operated member each include a slide portion facing an inner wall surface of the cylindrical body, which surrounds the internal space of the cylindrical body, and capable of sliding in the internal space and shaped to allow the respective slide portions of the contact member and the operated member to slide along a centerline of the cylindrical body.

3. The force sensor unit according to claim 2, wherein:
a cross section of the internal space of the cylindrical body has a polygonal outline shape; and
the slide portion of the contact member is shaped to prevent the contact member from being rotated around the centerline of the cylindrical body by contacting the inner wall surface of the cylindrical body.

4. The force sensor unit according to claim 2, wherein:
a cross section of an outer peripheral surface of the cylindrical body has a polygonal outline shape;
the blocking member includes a substrate having a front surface positioned on a side of the internal space of the cylindrical body, on which the force sensor is mounted, and a back surface having a plurality of electrodes provided thereon and exposed externally from the cylindrical body; and
an outline shape of the substrate is the same as or similar to the outline shape of the cross section of the outer peripheral surface of the cylindrical body.

5. The force sensor unit according to claim 1, wherein the elastic member is formed of a coil spring.

6. The force sensor unit according to claim 1, wherein:
the elastic member has an elastic constant that is defined to maximize a stroke of the operated member when a maximum allowable measurement force is applied to the force sensor.

7. The force sensor unit according to claim 1, wherein:
the blocking member includes a substrate having a front surface positioned on a side of the internal space of the cylindrical body, on which the force sensor is mounted, and a back surface having a plurality of electrodes provided thereon and exposed externally from the cylindrical body; and
the cylindrical body is metallic and includes two or more claw portions at the one end of the cylindrical body, the claw portions being bent in the radially inward direction to contact the back surface of the substrate.

8. The force sensor unit according to claim 7, wherein:
an abutted portion is provided on the front surface of the substrate to abut onto an end face of the one end of the cylindrical body; and
a plurality of recesses are formed in the back surface of the substrate to be engaged with the claw portions.

9. The force sensor unit according to claim 1, wherein the force receiving portion of the force sensor is a sphere.

10. The force sensor unit according to claim 3, wherein:
a cross section of an outer peripheral surface of the cylindrical body has a polygonal outline shape;
the blocking member includes a substrate having a front surface positioned on a side of the internal space of the cylindrical body, on which the force sensor is mounted, and a back surface having a plurality of electrodes provided thereon and exposed externally from the cylindrical body; and
an outline shape of the substrate is the same as or similar to the outline shape of the cross section of the outer peripheral surface of the cylindrical body.

11. The force sensor unit according to claim 2, wherein the elastic member is formed of a coil spring.

12. The force sensor unit according to claim 2, wherein:
the elastic member has an elastic constant that is defined to maximize a stroke of the operated member when a maximum allowable measurement force is applied to the force sensor.

13. The force sensor unit according to claim 3, wherein:
the elastic member has an elastic constant that is defined to maximize a stroke of the operated member when a maximum allowable measurement force is applied to the force sensor.

14. The force sensor unit according to claim 4, wherein:
the elastic member has an elastic constant that is defined to maximize a stroke of the operated member when a maximum allowable measurement force is applied to the force sensor.

15. The force sensor unit according to claim 5, wherein:
the elastic member has an elastic constant that is defined to maximize a stroke of the operated member when a maximum allowable measurement force is applied to the force sensor.

16. The force sensor unit according to claim 2, wherein:
the blocking member includes a substrate having a front surface positioned on a side of the internal space of the cylindrical body, on which the force sensor is mounted, and a back surface having a plurality of electrodes provided thereon and exposed externally from the cylindrical body; and
the cylindrical body is metallic and includes two or more claw portions at the one end of the cylindrical body, the claw portions being bent in the radially inward direction to contact the back surface of the substrate.

17. The force sensor unit according to claim 16, wherein:
an abutted portion is provided on the front surface of the substrate to abut onto an end face of the one end of the cylindrical body; and
a plurality of recesses are formed in the back surface of the substrate to be engaged with the claw portions.

18. The force sensor unit according to claim 2, wherein the force receiving portion of the force sensor is a sphere.
